(19) United States
(12) Patent Application Publication
(10) Pub. No.: US 2026/0221105 A1
(43) Pub. Date: Jul. 30, 2026

(54) Display Apparatus Including Narrow Bezel

(71) Applicant: LG Display Co., Ltd., Seoul (KR)

(72) Inventors: Ye Seul Han, Paju-si (KR); Hong Sik Kim, Paju-si (KR); Kwang Hyun Choi, Paju-si (KR)

(21) Appl. No.: 19/395,894

(22) Filed: Nov. 20, 2025

(30) Foreign Application Priority Data
Jan. 24, 2025 (KR) 10-2025-0011983

(51) Int. Cl. G09G 3/3266; G09G 3/00

(52) U.S. Cl. CPC G09G 3/3266; G09G 3/006; G09G 2300/0408; G09G 2310/0286; G09G 2310/08; G09G 2330/08

(57) ABSTRACT

A display apparatus presented herein includes a first S1 set disposed in a first display area of a display panel and configured to output an S1 output, needed for pixel driving, to first scan lines of the first display area, a second S1 set disposed in a second display area of the display panel and configured to output the S1 output to first scan lines of the second display area, and a plurality of first control transistors disposed in a third display area of the display panel disposed between the first display area and the second display area. The plurality of first control transistors are configured to turn on or off electrical connections between the first scan lines of the first display area and the first scan lines of the second display area, based on a first control clock signal.

### CROSS-REFERENCE TO RELATED APPLICATION

The present application claims the priority to Republic of Korea Patent Application No. 10-2025-0011983 filed on January 24, 2025, which is hereby incorporated by reference in its entirety.

### BACKGROUND

### Field

The present disclosure relates to a display apparatus.

### Discussion of Related Art

In display apparatuses, the demand for a narrow bezel where a width of a non-display area is narrow is increasing, and to this end, technology for placing a gate driver in a gate driver in active area (GIA) type has been known.

However, in a conventional GIA type, because gate drivers are distributed and disposed in a display area, it is impossible to detect an accurate defect position and perform a repair process on the gate drivers, and due to this, a yield rate of display panels may be reduced.

### SUMMARY

To overcome the aforementioned problem of the related art, the present disclosure may provide a display apparatus which may determine whether a gate output is normal or not, based on gate driver sets distributed and disposed in a display area.

To achieve these objects and other advantages and in accordance with the purpose of the disclosure, as embodied and broadly described herein, a display apparatus includes: a first S1 set disposed in a first display area of a display panel and configured to output an S1 output, needed for pixel driving, to first scan lines of the first display area; a second S1 set disposed in a second display area of the display panel and configured to output the S1 output to first scan lines of the second display area; and a plurality of first control transistors disposed in a third display area of the display panel disposed between the first display area and the second display area and configured to turn on or off electrical connections between the first scan lines of the first display area and the first scan lines of the second display area, based on a first control clock signal.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating a display apparatus according to one or more embodiments of the present disclosure.

FIG. 2 is a schematic cross-sectional view of a display area of a display panel according to one or more embodiments of the present disclosure.

FIG. 3A is a diagram illustrating a pixel circuit according to one or more embodiments of the present disclosure.

FIG. 3B is a diagram illustrating a driving timing of a pixel circuit of FIG. 3A.

FIG. 4 is a diagram illustrating an arrangement example of gate driver sets based on a gate driver in active area (GIA) type according to one or more embodiments of the present disclosure.

FIG. 5 is an enlarged view of a region XY of FIG. 4.

FIG. 6 is a diagram illustrating an example of a first scan unit included in a first scan driver set or a second scan unit included in a second scan driver set according to one or more embodiments of the present disclosure.

FIG. 7 is a diagram illustrating an example where circuit blocks configuring a first scan unit or a second scan unit are distributed and disposed in four pixel rows included in a display area according to one or more embodiments of the present disclosure.

FIG. 8 is a diagram illustrating an example of an emission unit included in an emission driver set according to one or more embodiments of the present disclosure.

FIG. 9 is a diagram illustrating an example where circuit blocks configuring an emission unit are distributed and disposed in four pixel rows included in a display area according to one or more embodiments of the present disclosure.

FIG. 10 is a diagram illustrating a display apparatus where a control block is disposed between gate driver sets distributed and disposed in first and second display areas so that whether a gate output is normal or not is determined according to one or more embodiments of the present disclosure.

FIG. 11 is a diagram illustrating a connection structure of FIG. 10 in detail.

FIG. 12 is a diagram illustrating an example where gate lines of a first display area and gate lines of a second display area are divisionally driven by control transistors of a control block in a normal display mode and a test mode according to one or more embodiments of the present disclosure.

FIGS. 13 to 15 are diagrams illustrating an example where an output of one-side defect gate driver set is disabled, and gate lines of a first display area and gate lines of a second display area are coupled to an output of the other-side normal gate driver set, in a repair mode according to one or more embodiments of the present disclosure.

### DETAILED DESCRIPTION

Hereinafter, embodiments of the present disclosure will be described in detail with reference to the accompanying drawings. In the present disclosure, in adding reference numerals for elements in each drawing, it should be noted that like reference numerals already used to denote like elements in other drawings are used for elements wherever possible. In the following description, when the detailed description of the relevant known function or configuration is determined to unnecessarily obscure the important point of the present disclosure, the detailed description will be omitted.

Like reference numerals refer to like elements. Also, a thickness, a ratio, and a dimension of each element described herein are illustrated to be partially enlarged or reduced for convenience of effective description. A scale of each element illustrated in the drawings of the present disclosure may have a scale which differs from a real scale, for convenience of description, but is not limited to a scale illustrated in the drawings.

In the present disclosure, when an arbitrary element (or a region, a layer, a portion, etc.) is described as “being on”, "connected", or "coupled", this may denote that the arbitrary element may be directly connected/coupled to another element, or a third element may be disposed therebetween.

The term "and/or" may include all of one or more combinations capable of being defined by relevant elements.

Terms like a first and a second may be used to describe various elements, but the elements should not be limited by the terms. The terms may be used only as object for distinguishing an element from another element. For example, without departing from the spirit and scope of the inventive concept, a first element may be referred to as a second element, and similarly, the second element may be referred to as the first element. The terms of a singular form may include plural forms unless referred to the contrary.

The terms "under", "below", "on", and "above" may be used to describe a correlation between elements illustrated in the drawings. The terms may be a relative concept and may be described with respect to a direction illustrated in the drawings. For example, unless "just" or "direct" is used, one or more other elements between two elements may be disposed. Spatially relative terms “below”, “beneath”, “lower”, “above”, and “upper” may be used herein for easily describing a relationship between one device or elements and other devices or elements as illustrated in the drawings. Therefore, for example, "under” and "lower" may be opposite to "on" and "upper" with respect to a first element.

It should be understood that spatially relative terms are terms including different orientations of elements in use or operation, in addition to the orientation illustrated in the drawings. For example, if a device in the drawings is turned over, elements described as being on the “below” or “beneath” sides of other elements may be placed on “above” sides of the other elements. Therefore, the exemplary term “lower” may include both orientations of “lower” and “upper”. Likewise, the exemplary term “above” or “upper” may include both orientations of above and below.

It should be understood that the meaning of “include,” “comprise,” “including,” or “comprising,” specifies a property, a region, a fixed number, a step, a process, an element and/or a component, but does not exclude other properties, regions, fixed numbers, steps, processes, elements and/or components.

Features of various embodiments of the present disclosure may be partially or overall coupled to or combined with each other and may be variously inter-operated with each other and driven technically as those skilled in the art can sufficiently understand. The embodiments of the present disclosure may be carried out independently from each other, or may be carried out together in co-dependent relationship.

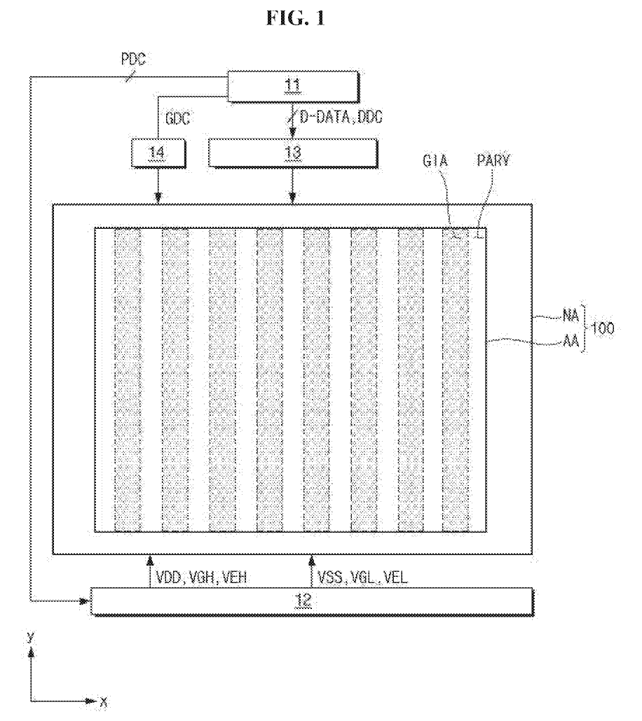

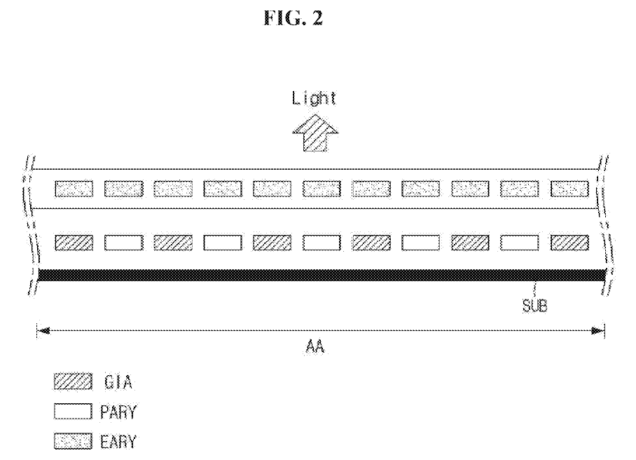

FIG. 1 is a block diagram illustrating a display apparatus according to one or more embodiments of the present disclosure. FIG. 2 is a schematic cross-sectional view of a display area of a display panel according to one or more embodiments of the present disclosure.

As illustrated in FIG. 1, the display apparatus according to one or more embodiments of the present disclosure may include a display panel 100, a timing controller 11, a power circuit 12, a data driver 13, a plurality of gate driver sets GIA, and a level shifter 14.

The display panel 100 may include a display area (active area) AA and a non-display area (non-active area) NA. The non-display area NA may be disposed along an edge of the display panel 100, and the non-display area NA may be disposed outside the display area AA in the display panel 100.

The display area AA may display an image corresponding to image data D-DATA, and the non-display area NA may include a bezel region, which does not display an image, of the display panel 100.

As illustrated in FIG. 2, a plurality of pixel circuits PARY and a plurality of gate driver sets GIA may be alternately arranged in the display area AA. In the display area AA, the pixel circuits PARY and the gate driver sets GIA may be disposed under an emission array EARY and may at least partially overlap the emission array EARY. The emission array EARY may be implemented with a plurality of light emitting devices OLED. Light emitted from each of the light emitting devices OLED may be irradiated upward from a substrate SUB. One pixel may be implemented by a combination of one pixel circuit PARY and one light emitting device OLED. A plurality of pixels may be provided as a matrix type to configure a pixel array, in the display area AA.

The plurality of pixel circuits PARY and the plurality of gate driver sets GIA may be alternately arranged in a first direction x (for example, a horizontal direction), and the gate driver sets GIA may be arranged between the pixel circuits PARY. Each of the plurality of pixel circuits PARY and the plurality of gate driver sets GIA may extend in a second direction y (for example, a vertical direction) intersecting the first direction x.

In the display area AA, a plurality of data lines extending in the second direction y may intersect a plurality of gate lines extending in the first direction x in the display area AA, and the pixel circuit PARY may be disposed in each of areas defined by intersections between the plurality of data lines and the plurality of gate lines. Each pixel circuit PARY may be connected to one data line and three gate lines. The three gate lines may include a first scan line, a second scan line, and an emission line.

In the display area AA, pixels adjacent to each other in the first direction x may configure a pixel row, and pixels adjacent to each other in the second direction y may configure a pixel column. A plurality of pixel rows and a plurality of pixel columns may be provided in the display area AA.

A plurality of pixels may be grouped to configure one unit pixel. The one unit pixel may be for implementing various colors. When a pixel group for color implementation is defined as a unit pixel, one unit pixel may be configured to include a red (R) pixel, a green (G) pixel, and a blue (B) pixel, but is not limited thereto and may be configured to include a red (R) pixel, a green (G) pixel, a blue (B), and a white (W) pixel.

The light emitting device OLED may include an anode electrode, a cathode electrode, and an organic compound layer formed therebetween. The organic compound layer may include a hole injection layer (HIL), a hole transport layer (HTL), an emission layer (EML), an electron transport layer (ETL), and an electron injection layer (EIL), but is not limited thereto. When a pixel current flows in the light emitting device OLED, a hole passing through the hole transport layer (HTL) and an electron passing through the electron transport layer (ETL) may move to the emission layer (EML) to generate an exciton, and thus, the emission layer (EML) may emit visible light. Also, the organic compound layer may be replaced with an inorganic compound layer.

A thin film transistor included in the pixel circuit PARY may be implemented to include low temperature polysilicon (LTPS) or oxide.

The timing controller 11 may supply digital image data D-DATA, transferred from a host system, to the data driver 13. The timing controller 11 may receive a timing signal such as a vertical synchronization signal, a horizontal synchronization signal, a data enable signal, and a dot clock from the host system to generate timing control signals for controlling operation timings of the data driver 13, the gate driver sets GIA, and the power circuit 12.

The timing controller 11 may generate a gate timing control signal GDC for controlling the operation timings of the gate driver sets GIA, a data timing control signal DDC for controlling the operation timing of the data driver 13, and a power timing control signal PDC for controlling the operation timing of the power circuit 12.

The host system may be an application processor (AP) applied to mobile devices, wearable devices, and virtual/augmented reality (VR/AR) devices. Also, the host system may be a main board of television systems, set-top box, navigation systems, personal computers, and home theater systems, but is not limited thereto.

The data driver 13 may be connected to the plurality of pixels through the plurality of data lines. The data driver 13 may generate analog data voltages needed for driving of the pixels and may respectively supply the analog data voltages to the data lines.

The data driver 13 may sample and latch the digital image data D-DATA input from the timing controller 11 to generate parallel data, based on the data timing control signal DDC, a digital-to-analog converter (DAC) thereof may map the digital image data D-DATA to gamma compensation voltages to generate data voltages, and the data driver 13 may respectively supply the data voltages to the pixels through the data lines. The data voltages may be analog voltages corresponding to image gray levels which are to be expressed in the pixels.

The data driver 13 may include a plurality of source driver integrated circuits (ICs). Each of the source driver ICs may include a shift register, a latch, the DAC, and an output buffer.

The gate driver sets GIA may include a plurality of emission driver sets, a plurality of first scan driver sets, a plurality of second scan driver sets, and a plurality of control blocks. Hereinafter, the emission driver set may be referred to as an "EM set", the first scan driver set may be referred to as an "S1 set", and the second scan driver set may be referred to as an "S2 set".

The plurality of EM sets may be connected to the plurality of pixels through a plurality of emission lines. The plurality of EM sets may generate an emission signal needed for driving of the pixels and may supply the emission signal to the emission lines. The plurality of EM sets may be multiply connected to a plurality of positions of the emission line, and thus, a delay deviation of the emission signal depending on a position may be reduced.

The plurality of S1 sets may be connected to a plurality of pixels through a plurality of first scan lines. The plurality of S1 sets may generate a first scan signal needed for driving of the pixels and may supply the first scan signal to the first scan lines. The plurality of S1 sets may be multiply connected to a plurality of positions of the first scan line, and thus, a delay deviation of the first scan signal depending on a position may be reduced.

The plurality of S2 sets may be connected to a plurality of pixels through a plurality of second scan lines. The plurality of S2 sets may generate a second scan signal needed for driving of the pixels and may supply the second scan signal to the second scan lines. The plurality of S2 sets may be multiply connected to a plurality of positions of the second scan line, and thus, a delay deviation of the second scan signal depending on a position may be reduced.

The plurality of control blocks may turn on or off electrical connections between emission lines between adjacent EM sets. The plurality of control blocks may turn on or off electrical connections between first scan lines between adjacent S1 sets. The plurality of control blocks may turn on or off electrical connections between second scan lines between adjacent S2 sets.

The level shifter 14 may be supplied with the gate timing control signal GDC from the timing controller 11 to convert a logic voltage level of the gate timing control signal GDC into a turn-on voltage level and a turn-off voltage level and may supply a level-converted gate timing control signal GDC to the gate driver sets GIA. The gate timing control signal GDC may include emission clocks, first scan clocks, second scan clocks, and control clocks.

The level shifter 14 may supply the emission clocks to the plurality of EM sets through emission clock lines disposed in the display area AA. The level shifter 14 may supply the first scan clocks to the plurality of S1 sets through first scan clock lines disposed in the display area AA. The level shifter 14 may supply the second scan clocks to the plurality of S2 sets through second scan clock lines disposed in the display area AA. The level shifter 14 may supply the control clocks to the control blocks through control clock lines disposed in the display area AA.

The emission clocks, the first scan clocks, the second scan clocks, and the control clocks may swing between a turn-on voltage and a turn-off voltage. The turn-on voltage may be set to a voltage which is greater than a threshold voltage of a transistor included in each of the gate driver sets GIA, and the turn-off voltage may be set to a voltage which is less than the threshold voltage of the transistor. When the transistor included in each of the gate driver sets GIA is a PMOS transistor, the turn-on voltage may be a gate low voltage VGL (VEL), and the turn-off voltage may be a gate high voltage VGH (VEH).

The power circuit 12 may increase or decrease an input power to generate a high-level pixel voltage VDD and a low-level pixel voltage VSS, based on the power timing control signal PDC, and may supply the high-level pixel voltage VDD or the low-level pixel voltage VSS to the plurality of pixel circuits PARY. The power circuit 12 may increase or decrease the input power to generate a high-level driving voltage VGH (VEH) and a low-level driving voltage VGL (VEL), based on the power timing control signal PDC, and may supply the high-level driving voltage VGH (VEH) or the low-level driving voltage VGL (VEL) to the plurality of gate driver sets GIA.

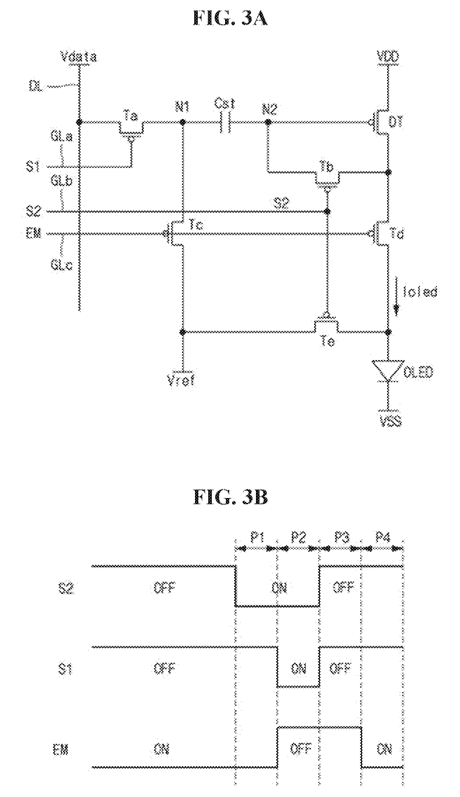

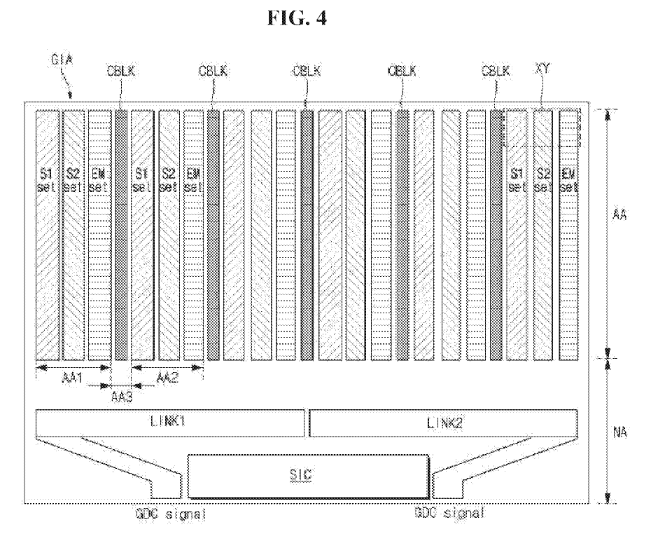

FIG. 3A is a diagram illustrating a pixel circuit according to one or more embodiments of the present disclosure. FIG. 3B is a diagram illustrating a driving timing of a pixel circuit of FIG. 3A.

As illustrated in FIG. 3A, a pixel circuit according to one or more embodiments of the present disclosure may include Ta, Tb, Tc, Td, and Te transistors, a storage capacitor Cst, a driving transistor DT, and a light emitting device OLED.

The Ta transistor may include a gate electrode receiving a first scan signal S1 through a first scan line GLa, a first electrode receiving a data voltage Vdata through a data line DL, and a second electrode connected to a first node N1. The Ta transistor may transfer the data voltage Vdata to the first node N1 in response to the first scan signal S1 of a turn-on level.

The storage capacitor Cst may be connected between the first node N1 and a second node N2 and may store a difference voltage between a voltage of the first node N1 and a voltage of the second node N2.

The driving transistor DT may include a gate electrode connected to the second node N2, a first electrode receiving a high-level driving voltage VDD, and a second electrode electrically connected to the light emitting device OLED. The driving transistor DT may be supplied with the high-level driving voltage VDD to generate a driving current corresponding to the voltage of the second node N2. A magnitude of the driving current may be differently generated based on the voltage of the second node N2.

The Tb transistor may include a gate electrode receiving a second scan signal S2 through a second scan line GLb, a first electrode connected to the second electrode of the driving transistor DT, and a second electrode connected to the second node N2. The Tb transistor may electrically connect the second electrode of the driving transistor DT to the second node N2 in response to the second scan signal S2 of a turn-on level. That is, while the Tb transistor is being turned on, the second electrode and the gate electrode of the driving transistor DT may be short-circuited therebetween, and thus, the driving transistor DT may operate like a diode.

The Tc transistor may include a gate electrode receiving an emission signal EM through an emission line GLc, a first electrode receiving a reference voltage Vref, and a second electrode connected to the first node N1. The Tc transistor may supply the reference voltage Vref to the first node N1 to initialize the first node N1, in response to the emission signal EM of a turn-on level.

The Td transistor may include a gate electrode receiving the emission signal EM, a first electrode connected to the driving transistor DT, and a second electrode connected to the light emitting device OLED. The Td transistor may supply the driving current, generated by the driving transistor DT, to the light emitting device OLED in response to the emission signal EM of a turn-on level.

The Te transistor may include a gate electrode receiving the second scan signal S2 through the second scan line GLb, a first electrode receiving the reference voltage Vref, and a second electrode connected to the anode electrode of the light emitting device OLED. The Te transistor may supply the reference voltage Vref to the anode electrode of the light emitting device OLED to initialize the anode electrode of the light emitting device OLED, in response to the second scan signal S2 of a turn-on level.

As illustrated in FIG. 3B, an operation sequence of the pixel circuit may include an initialization period P1, a programming period P2, a holding period P3, and an emission period P4.

In the initialization period P1, the second scan signal S2 and the emission signal EM may be input at a turn-on level, and the first node N1, the second node N2, and the anode electrode of the light emitting device OLED may be supplied with the reference voltage Vref and may thus be initialized.

In the programming period P2, a threshold voltage Vth of the driving transistor DT may be sampled, and the data voltage Vdata may be programmed in the second node N2. In detail, in the programming period P2, the first scan signal S1 and the second scan signal S2 may be input at a turn-on level, and thus, the data voltage Vdata may be supplied to the first node N1, and a voltage obtained by summating a driving voltage VDD and the threshold voltage Vth of the driving transistor DT may be supplied to the second node N2 and may be stored in the storage capacitor Cst.

In the holding period P3, the first and second scan signals S1 and S2 and the emission signal EM may be input at a turn-off level, and thus, the first and second nodes N1 and N2 connected to the storage capacitor Cst may be floated.

In the emission period P4, the emission signal EM may be input at a turn-on level, and thus, the driving transistor DT may generate the driving current to supply the driving current to the light emitting device OLED, based on a voltage level of the second node N2 connected to the storage capacitor Cst.

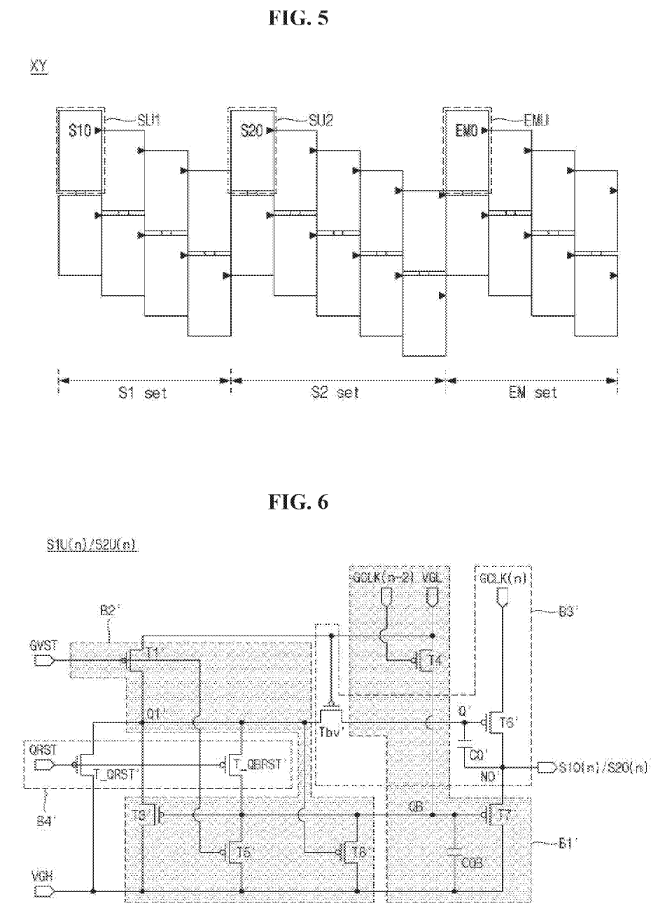

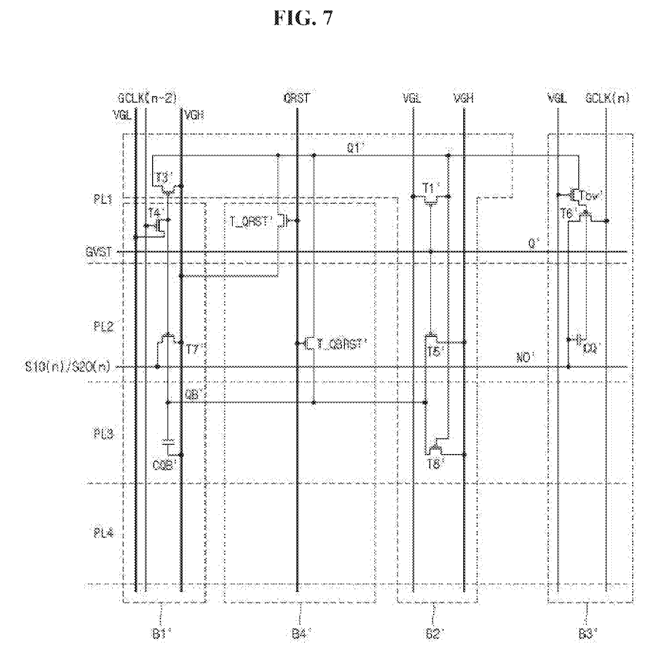

FIG. 4 is a diagram illustrating an arrangement example of gate driver sets based on a gate driver in active area (GIA) type according to one or more embodiments of the present disclosure. FIG. 5 is an enlarged view of a region XY of FIG. 4.

Referring to FIGS. 4 and 5, a plurality of gate driver sets GIA may be distributed and disposed in a display area. The gate driver sets GIA may include a plurality of S1 sets, a plurality of S2 sets, a plurality of EM sets, and a plurality of control blocks CBLK.

The S1 set may supply first scan signals S1, where phases thereof are sequentially shifted, to first scan lines of the display area. The first scan signal S1 may be referred to as an S1 output S1O. The S1 set may include S1 units SU1 equal to the number of first scan lines. S1 outputs S1O of the S1 units SU1 may be connected to the first scan lines. Each of the S1 units SU1 may include a plurality of circuit blocks. For example, circuit blocks configuring the S1 unit SU1 may be distributed and disposed in a pixel area of a 6 pixels * 4 pixels (i.e., 24 pixels) size, but is not limited thereto.

The S2 set may supply second scan signals S2, where phases thereof are sequentially shifted, to second scan lines of the display area. The second scan signal S2 may be referred to as an S2 output S2O. The S2 set may include S2 units SU2 equal to the number of second scan lines. S2 outputs S2O of the S2 units SU2 may be connected to the second scan lines. Each of the S2 units SU2 may include a plurality of circuit blocks. For example, circuit blocks configuring the S2 unit SU2 may be distributed and disposed in a pixel area of a 6 pixels * 5 pixels (i.e.,30 pixels) size, but is not limited thereto.

The EM set may supply emission signals EM, where phases thereof are sequentially shifted, to emission lines of the display area. The emission signal EM may be referred to as an EM output EMO. The EM set may include emission units EMU equal to the number of emission lines. Outputs EMO of the emission units EMU may be connected to the emission lines. Each of the emission units EMU may include a plurality of circuit blocks. Circuit blocks configuring the emission unit EMU may be distributed and disposed in a pixel area of an 8 pixels * 4 pixels (i.e., 32 pixels) size, but is not limited thereto.

In the display area, a plurality of S1 sets may be distributed and disposed, a plurality of S2 sets may be distributed and disposed, and a plurality of EM sets may be distributed and disposed. For example, the S1 sets, the S2 sets, and the EM sets may be repeatedly arranged in a set sequence of S1-S2-EM up to the right of the display area from the left of the display area.

When S1-S2-EM are disposed in a first display area AA1, and S1-S2-EM are disposed in a second display area AA2, a control block CBLK may be disposed in each third display area AA3 between the first and second display area AA1 and AA2.

In the third display area AA3, the control block CBLK may divide or connect gate lines of the first display area AA1 and gate lines of the second display area AA2, and thus, a configuration for determining whether a gate output is normal or not may be provided with respect to an S1-S2-EM set distributed and disposed in the display area AA. The control block CBLK may be implemented with a plurality of control transistors.

Gate driver sets GIA of a first group may be disposed in a left display area managed by one source driver IC SIC, and gate driver sets GIA of a second group may be disposed in a right display area.

The gate driver sets GIA of the first group may be supplied with a gate timing control signal GDC through first link lines LINK1 included in a lower non-display area, and the gate driver sets GIA of the second group may be supplied with the gate timing control signal GDC through second link lines LINK2 included in the lower non-display area. Because the first link lines LINK1 and the second link lines LINK2 are isolated from each other, a delay of the gate timing control signal GDC may be reduced.

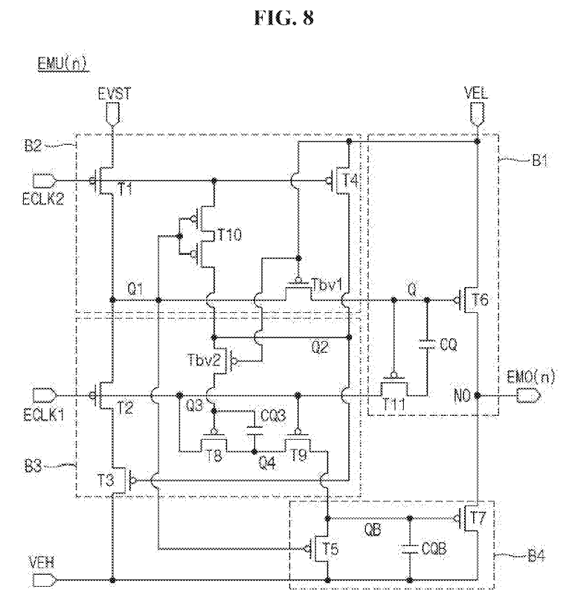

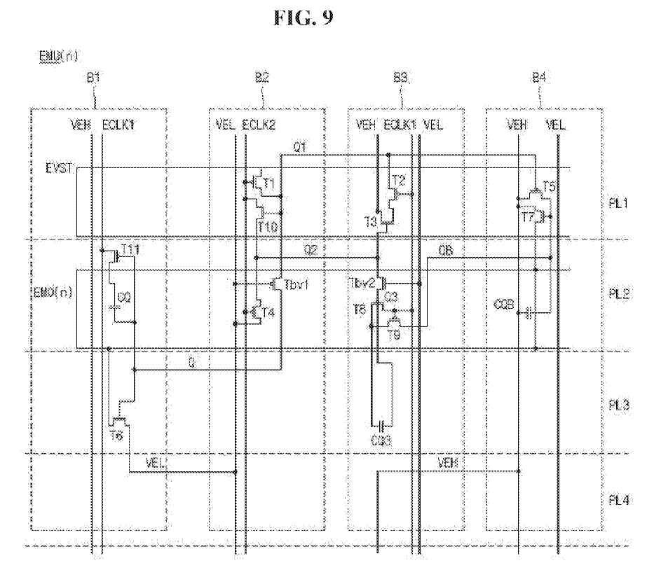

FIG. 6 is a diagram illustrating an example of an S1 unit included in an S1 set or an S2 unit included in an S2 set according to one or more embodiments of the present disclosure. FIG. 7 is a diagram illustrating an example where circuit blocks configuring the S1 unit or the S2 unit are distributed and disposed in four pixel rows according to one or more embodiments of the present disclosure.

Referring to FIGS. 6 and 7, each of an S1 unit S1U(n) and an S2 unit S2U(n) may be implemented as a shift register type. An S1 output S1O(n) corresponding to a scan clock GCLK(n) may be generated in an output node NO' of the S1 unit S1U(n), and an S2 output S2O(n) corresponding to the scan clock GCLK(n) may be generated in an output node NO' of the S2 unit S2U(n).

Each of the S1 unit S1U(n) and the S2 unit S2U(n) may be divided into a first block B1', a second block B2', a third block B3', and a fourth block B4'. Each of the S1 unit S1U(n) and the S2 unit S2U(n) may be distributed and disposed in four pixel rows PL1 to PL4 included in a display area.

The first block B1' may include a T4' transistor, a CQB' capacitor, and a T7' transistor.

A gate electrode of the T4' transistor may be connected to an input terminal of a scan clock GCLK(n-2), a first electrode thereof may be connected to a low-level driving voltage VGL, and a second electrode thereof may be connected to a QB' node. A gate electrode of the T7' transistor may be connected to the QB' node, a first electrode thereof may be connected to an output node NO', and a second electrode thereof may be connected to a high-level driving voltage VGH. The CQB' capacitor may be connected to the QB' node and the high-level driving voltage VGH. The second block B2' may include a T1' transistor, a T3' transistor, a T5' transistor, and a T8' transistor.

A gate electrode of the T1' transistor may be connected to a start signal GVST or a front-end output (a carry signal S10(n-1) or S20(n-1)), a first electrode thereof may be connected to the low-level driving voltage VGL, and a second electrode thereof may be connected to a Q1' node. A gate electrode of the T3' transistor may be connected to the QB' node, a first electrode thereof may be connected to the Q1' node, and a second electrode thereof may be connected to the high-level driving voltage VGH. A gate electrode of the T5' transistor may be connected to the start signal GVST or a front-end output, a first electrode thereof may be connected to the QB' node, and a second electrode thereof may be connected to the high-level driving voltage VGH. A gate electrode of the T8' transistor may be connected to the Q1' node, a first electrode thereof may be connected to the QB' node, and a second electrode thereof may be connected to the high-level driving voltage VGH.

The third block B3' may include a Tbv' transistor, a T6' transistor, and a CQ' capacitor.

A gate electrode of the Tbv' transistor may be connected to the low-level driving voltage VGL, a first electrode thereof may be connected to the Q1' node, and a second electrode thereof may be connected to the Q' node. A gate electrode of the T6' transistor may be connected to the Q' node, a first electrode thereof may be connected to an input terminal of a scan clock GCLK(n), and a second electrode thereof may be connected to the output node NO'. The CQ' capacitor may be connected to the Q' node and the output node NO'.

The fourth block B4' may include a T_QRST' transistor and a T_QBRST' transistor.

A gate electrode of the T_QRST' transistor may be connected to an input terminal of a rear-end carry signal or a reset signal QRST, a first electrode thereof may be connected to the Q1' node, and a second electrode thereof may be connected to the high-level driving voltage VGH. A gate electrode of the T_QBRST' transistor may be connected to an input terminal of a rear-end carry signal or the reset signal QRST, a first electrode thereof may be connected to the Q1' node, and a second electrode thereof may be connected to the QB' node.

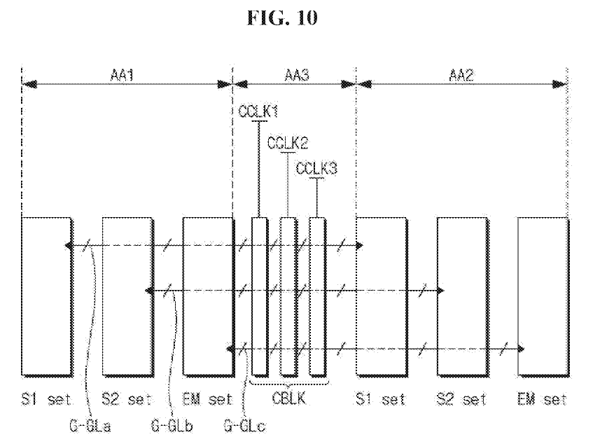

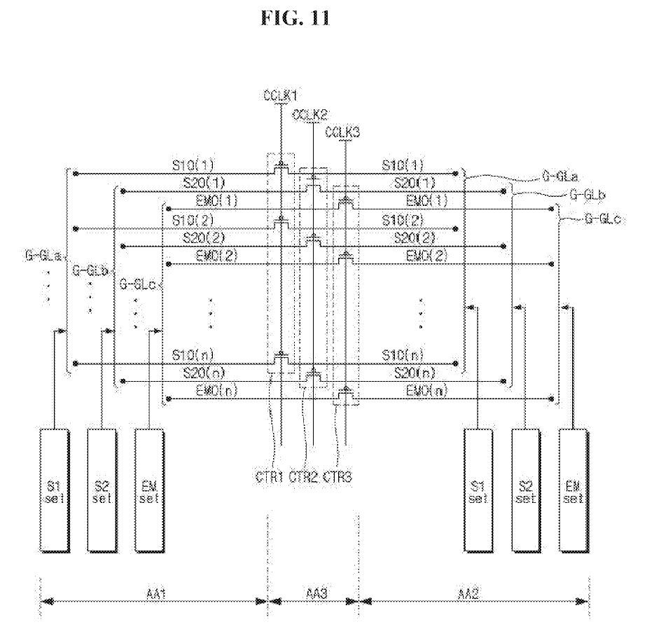

FIG. 8 is a diagram illustrating an example of an EM unit included in an EM set according to one or more embodiments of the present disclosure. FIG. 9 is a diagram illustrating an example where circuit blocks configuring an EM unit are distributed and disposed in four pixel rows according to one or more embodiments of the present disclosure.

Referring to FIGS. 8 and 9, an EM unit EMU(n) may be implemented as an edge trigger type. The EM unit EMU(n) may be divided into a first block B1, a second block B2, a third block B3, and a fourth block B4. The EM unit EMU(n) may be distributed and disposed in four pixel rows PL1 to PL4 included in a display area.

The first block B1 may include a T6 transistor, a CQ capacitor, and a T11 transistor.

A gate electrode of the T6 transistor may be connected to a Q node, a first electrode thereof may be connected to a low-level driving voltage VEL, and a second electrode thereof may be connected to an output node NO. A gate electrode of the T11 transistor may be connected to the Q node, a first electrode thereof may be connected to the CQ capacitor, and a second electrode thereof may be connected to an input terminal of a first emission clock ECLK1. The CQ capacitor may be connected to the Q node and the first electrode of the T11 transistor.

The second block B2 may include a T1 transistor, a T4 transistor, a T10 transistor, and a Tbv1 transistor.

A gate electrode of the T1 transistor may be connected to an input terminal of a second emission clock ECLK2, a first electrode thereof may be connected to a start signal EVST or a front-end output (a carry signal), and a second electrode thereof may be connected to a Q1 node. A gate electrode of the T4 transistor may be connected to the input terminal of the second emission clock ECLK2, a first electrode thereof may be connected to the low-level driving voltage VEL, and a second electrode thereof may be connected to a Q2 node. A gate electrode of the T10 transistor may be connected to the Q1 node, a first electrode thereof may be connected to the input terminal of the second emission clock ECLK2, and a second electrode thereof may be connected to the Q2 node. A gate electrode of the Tbv1 transistor may be connected to the low-level driving voltage VEL, a first electrode thereof may be connected to the Q node, and a second electrode thereof may be connected to the Q1 node.

The third block B3 may include a T2 transistor, a T3 transistor, a T8 transistor, a T9 transistor, a Tbv2 transistor, and a CQ3 capacitor.

A gate electrode of the T2 transistor may be connected to the input terminal of the first emission clock ECLK1, a first electrode thereof may be connected to the Q1 node, and a second electrode thereof may be connected to a first electrode of the T3 transistor. A gate electrode of the T3 transistor may be connected to the Q2 node, the first electrode thereof may be connected to the second electrode of the T2 transistor, and a second electrode thereof may be connected to a high-level driving voltage VEH. A gate electrode of the T8 transistor may be connected to a Q3 node, a first electrode thereof may be connected to the input terminal of the first emission clock ECLK1, and a second electrode thereof may be connected to a Q4 node. A gate electrode of the T9 transistor may be connected to the input terminal of the first emission clock ECLK1, a first electrode thereof may be connected to a Q4 node, and a second electrode thereof may be connected to the high-level driving voltage VEH. A gate electrode of the Tbv2 transistor may be connected to the low-level driving voltage VEL, a first electrode thereof may be connected to the Q2 node, and a second electrode thereof may be connected to the Q3 node. The CQ3 capacitor may be connected to the Q3 node and the Q4 node.

The third block B4 may include a T5 transistor, a T7 transistor, and a CQB capacitor.

A gate electrode of the T5 transistor may be connected to the Q1 node, a first electrode thereof may be connected to the QB node, and a second electrode thereof may be connected to the low-level driving voltage VEL. A gate electrode of the T7 transistor may be connected to the QB node, a first electrode thereof may be connected to the output node NQ, and a second electrode thereof may be connected to the high-level driving voltage VEH.

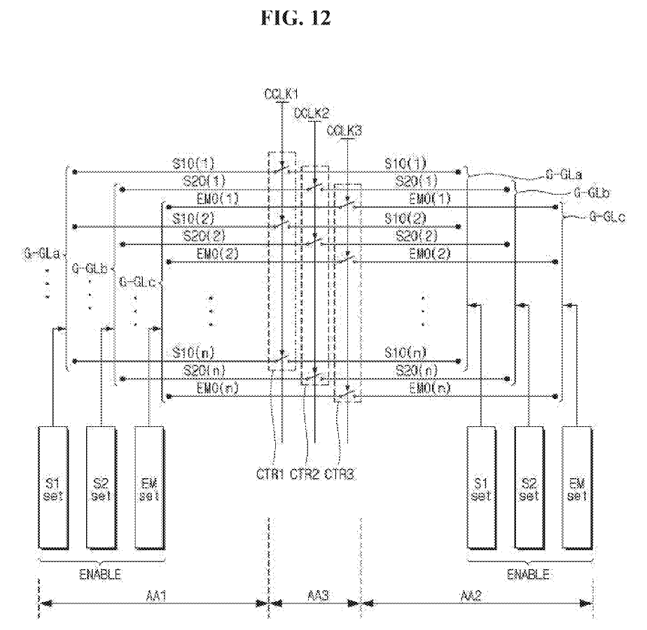

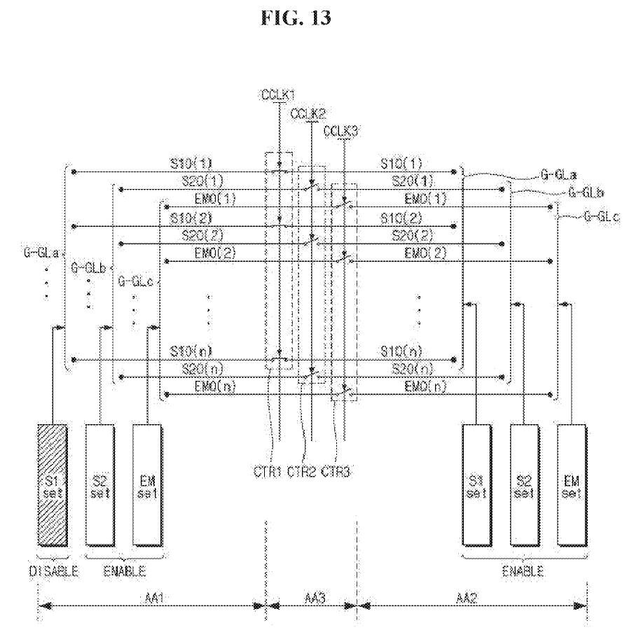

FIG. 10 is a diagram illustrating a display apparatus where a control block is disposed between gate driver sets distributed and disposed in first and second display areas so that whether a gate output is normal or not is determined according to one or more embodiments of the present disclosure. FIG. 11 is a diagram illustrating a connection structure of FIG. 10 in detail.

Referring to FIGS. 10 and 11, a display apparatus according to one or more embodiments of the present disclosure may include a first S1 set disposed in a first display area AA1 of a display panel, a second S1 set disposed in a second display area AA2 of the display panel, and a first control block CBLK disposed in a third display area AA3 of the display panel disposed between the first display area AA1 and the second display area AA2.

The first S1 set may be disposed in the first display area AA1 and may output S1 outputs S1O(1) to S1O(n), needed for pixel driving, to first scan lines G-GLa of the first display area AA1. The first S1 set may include a plurality of first S1 units which sequentially delay phases of the S1 outputs S1O(1) to S1O(n) to output phase-delayed S1 outputs S1O(1) to S1O(n) to the first scan lines G-GLa of the first display area AA1 (see FIG. 5). Each of the first S1 units may include a plurality of circuit blocks which are distributed and disposed in the first display area AA1 (see FIGS. 6 and 7).

The second S1 set may be disposed in the second display area AA2 and may output the S1 outputs S1O(1) to S1O(n), needed for pixel driving, to first scan lines G-GLa of the second display area AA2. The second S1 set may include a plurality of second S1 units which sequentially delay the phases of the S1 outputs S1O(1) to S1O(n) to output phase-delayed S1 outputs S1O(1) to S1O(n) to the first scan lines G-GLa of the second display area AA2 (see FIG. 5). Each of the second S1 units may include a plurality of circuit blocks which are distributed and disposed in the second display area AA2 (see FIGS. 6 and 7).

The first control block CBLK may be implemented with first control transistors CTR1. The first control transistors CTR1 may be disposed in the third display area AA3 and may turn on or off electrical connections between the first scan lines G-GLa of the first display area AA1 and the first scan lines G-GLa of the second display area AA2, based on a first control clock signal CCLK1.

Each of the first control transistors CTR1 may include a gate electrode to which the first control clock signal CCLK1 is input, a first electrode connected to one of the first scan lines G-GLa of the first display area AA1, and a second electrode connected to one of the first scan lines G-GLa of the second display area AA2.

Furthermore, referring further to FIGS. 10 and 11, the display apparatus according to one or more embodiments of the present disclosure may further include a first S2 set disposed in the first display area AA1 of the display panel, a second S2 set disposed in the second display area AA2 of the display panel, and a second control block CBLK disposed in the third display area AA3 of the display panel.

The first S2 set may be disposed in the first display area AA1 and may output S2 outputs S2O(1) to S2O(n), needed for pixel driving, to second scan lines G-GLb of the first display area AA1. The first S2 set may include a plurality of first S2 units which sequentially delay phases of the S2 outputs S2O(1) to S2O(n) to output phase-delayed S2 outputs S2O(1) to S2O(n) to the second scan lines G-GLb of the first display area AA1 (see FIG. 5). Each of the first S2 units may include a plurality of circuit blocks which are distributed and disposed in the first display area AA1 (see FIGS. 6 and 7).

The second S2 set may be disposed in the second display area AA2 and may output the S2 outputs S2O(1) to S2O(n), needed for pixel driving, to second scan lines G-GLb of the second display area AA2. The second S2 set may include a plurality of second S2 units which sequentially delay the phases of the S2 outputs S2O(1) to S2O(n) to output phase-delayed S2 outputs S2O(1) to S2O(n) to the second scan lines G-GLb of the second display area AA2 (see FIG. 5). Each of the second S2 units may include a plurality of circuit blocks which are distributed and disposed in the second display area AA2 (see FIGS. 6 and 7).

The second control block CBLK may be implemented with second control transistors CTR2. The second control transistors CTR2 may be disposed in the third display area AA3 and may turn on or off electrical connections between the second scan lines G-GLb of the first display area AA1 and the second scan lines G-GLb of the second display area AA2, based on a second control clock signal CCLK2.

Each of the second control transistors CTR2 may include a gate electrode to which the second control clock signal CCLK2 is input, a first electrode connected to one of the second scan lines G-GLb of the first display area AA1, and a second electrode connected to one of the second scan lines G-GLb of the second display area AA2.

Furthermore, referring further to FIGS. 10 and 11, the display apparatus according to one or more embodiments of the present disclosure may further include a first EM set disposed in the first display area AA1 of the display panel, a second EM set disposed in the second display area AA2 of the display panel, and a third control block CBLK disposed in the third display area AA3 of the display panel.

The first EM set may be disposed in the first display area AA1 and may output EM outputs EMO(1) to EMO(n), needed for pixel driving, to emission lines G-GLc of the first display area AA1. The first EM set may include a plurality of first EM units which sequentially delay phases of the EM outputs EMO(1) to EMO(n) to output phase-delayed EM outputs EMO(1) to EMO(n) to the emission lines G-GLc of the first display area AA1 (see FIG. 5). Each of the first EM units may include a plurality of circuit blocks which are distributed and disposed in the first display area AA1 (see FIGS. 6 and 7).

The second EM set may be disposed in the second display area AA2 and may output the EM outputs EMO(1) to EMO(n), needed for pixel driving, to emission lines G-GLc of the second display area AA2. The second EM set may include a plurality of second EM units which sequentially delay the phases of the EM outputs EMO(1) to EMO(n) to output phase-delayed EM outputs EMO(1) to EMO(n) to the emission lines G-GLc of the second display area AA2 (see FIG. 5). Each of the second EM units may include a plurality of circuit blocks which are distributed and disposed in the second display area AA2 (see FIGS. 6 and 7).

The third control block CBLK may be implemented with third control transistors CTR3. The third control transistors CTR3 may be disposed in the third display area AA3 and may turn on or off electrical connections between the emission lines G-GLc of the first display area AA1 and the emission lines G-GLc of the second display area AA2, based on a third control clock signal CCLK3.

Each of the third control transistors CTR3 may include a gate electrode to which the third control clock signal CCLK3 is input, a first electrode connected to one of the emission lines G-GLc of the first display area AA1, and a second electrode connected to one of the emission lines G-GLc of the second display area AA2.

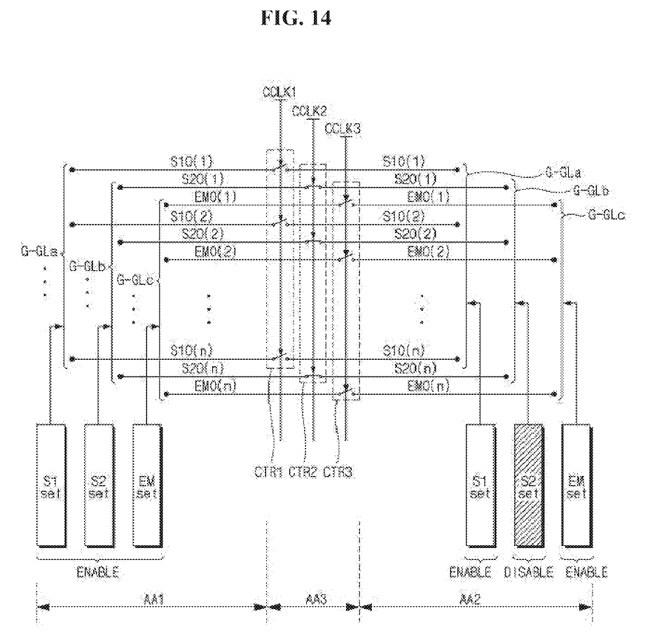

FIG. 12 is a diagram illustrating an example where gate lines of a first display area and gate lines of a second display area are divisionally driven by control transistors of a control block in a normal display mode and a test mode according to one or more embodiments of the present disclosure.

Referring to FIG. 12, in the normal display mode and the test mode, first control transistors CTR1 may turn off electrical connections between the first scan lines G-GLa of the first display area AA1 and the first scan lines G-GLa of the second display area AA2. In the normal display mode and the test mode, a plurality of first S1 units included in the first S1 set may sequentially delay phases of S1 outputs S1O(1) to S1O(n) to output phase-delayed S1 outputs S1O(1) to S1O(n) to the first scan lines G-GLa of the first display area AA1. In the normal display mode and the test mode, a plurality of second S1 units included in the second S1 set may sequentially delay the phases of the S1 outputs S1O(1) to S1O(n) to output phase-delayed S1 outputs S1O(1) to S1O(n) to the first scan lines G-GLa of the second display area AA2.

As a result, in each pixel row, one of the first scan lines G-GLa of the first display area AA1 and one of the first scan lines G-GLa of the second display area AA2 may be separated from each other by one of the first control transistors CTR1. Accordingly, in the test mode, whether the first S1 set is defective or not and whether the second S1 set is defective or not may be divisionally measured, and thus, a defect position of the S1 set may be easily measured.

When a defect of each of the first S1 set and the second S1 set is not detected, the normal display mode may be implemented. Even in the normal display mode, in each pixel row, one of the first scan lines G-GLa of the first display area AA1 and one of the first scan lines G-GLa of the second display area AA2 may be separated from each other by one of the first control transistors CTR1, and the first scan lines G-GLa of the first display area AA1 and the first scan lines G-GLa of the second display area AA2 may be divisionally driven.

Furthermore, referring further to FIG. 12, in the normal display mode and the test mode, second control transistors CTR2 may turn off electrical connections between the second scan lines G-GLb of the first display area AA1 and the second scan lines G-GLb of the second display area AA2. In the normal display mode and the test mode, a plurality of first S2 units included in the first S2 set may sequentially delay phases of S2 outputs S2O(1) to S2O(n) to output phase-delayed S2 outputs S2O(1) to S2O(n) to the second scan lines G-GLb of the first display area AA1. In the normal display mode and the test mode, the plurality of second S2 units included in the second S2 set may sequentially delay the phases of the S2 outputs S2O(1) to S2O(n) to output phase-delayed S2 outputs S2O(1) to S2O(n) to the second scan lines G-GLb of the second display area AA2.

As a result, in each pixel row, one of the second scan lines G-GLb of the first display area AA1 and one of the second scan lines G-GLb of the second display area AA2 may be separated from each other by one of the second control transistors CTR2. Accordingly, in the test mode, whether the first S2 set is defective or not and whether the second S2 set is defective or not may be divisionally measured, and thus, a defect position of the S2 set may be easily measured.

When a defect of each of the first S2 set and the second S2 set is not detected, the normal display mode may be implemented. Even in the normal display mode, in each pixel row, one of the second scan lines G-GLb of the first display area AA1 and one of the second scan lines G-GLb of the second display area AA2 may be separated from each other by one of the second control transistors CTR2, and the second scan lines G-GLb of the first display area AA1 and the second scan lines G-GLb of the second display area AA2 may be divisionally driven.

Furthermore, referring further to FIG. 12, in the normal display mode and the test mode, third control transistors CTR3 may turn off electrical connections between emission lines G-GLc of the first display area AA1 and emission lines G-GLc of the second display area AA2. In the normal display mode and the test mode, a plurality of first EM units included in the first EM set may sequentially delay phases of EM outputs EMO(1) to EMO(n) to output phase-delayed EM outputs EMO(1) to EMO(n) to the emission lines G-GLc of the first display area AA1. In the normal display mode and the test mode, a plurality of second EM units included in the second EM set may sequentially delay the phases of the EM outputs EMO(1) to EMO(n) to output phase-delayed EM outputs EMO(1) to EMO(n) to the emission lines G-GLc of the second display area AA2.

As a result, in each pixel row, one of the emission lines G-GLc of the first display area AA1 and one of the emission lines G-GLc of the second display area AA2 may be separated from each other by one of the third control transistors CTR3. Accordingly, in the test mode, whether the first EM set is defective or not and whether the second EM set is defective or not may be divisionally measured, and thus, a defect position of the EM set may be easily measured.

When a defect of each of the first EM set and the second EM set is not detected, the normal display mode may be implemented. Even in the normal display mode, in each pixel row, one of the emission lines G-GLc of the first display area AA1 and one of the emission lines G-GLc of the second display area AA2 may be separated from each other by one of the third control transistors CTR3, and the emission lines G-GLc of the first display area AA1 and the emission lines G-GLc of the second display area AA2 may be divisionally driven.

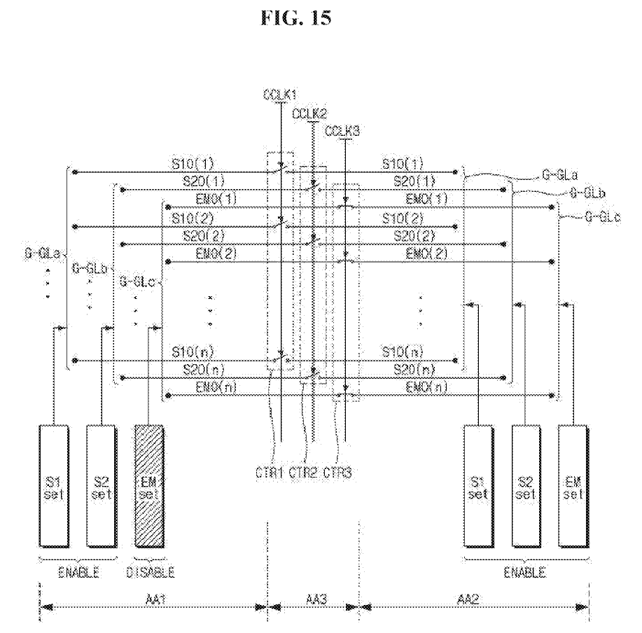

FIGS. 13 to 15 are diagrams illustrating an example where an output of one-side defect gate driver set is disabled, and gate lines of a first display area and gate lines of a second display area are coupled to an output of the other-side normal gate driver set, in a repair mode according to one or more embodiments of the present disclosure.

Referring to FIG. 13, in the repair mode, when at least one of a plurality of first S1 units included in the first S1 set or at least one of a plurality of second S1 units included in the second S1 set is defective, in the first S1 set and the second S1 set, all of S1 outputs S1O(1) to S1O(n) of an S1 set including a defective S1 unit may be disabled, and all of S1 outputs S1O(1) to S1O(n) of an S1 set including no defective S1 unit may be enabled.

In the S1 set including the defective S1 unit, when GCLK(n) of FIG. 6 supplied to the S1 units is blocked, the S1 outputs S1O(1) to S1O(n) may be disabled.

The S1 outputs S1O(1) to S1O(n) of the S1 set including the defective S1 unit may be disabled, and in this case, because first scan lines G-GLa of the first display area AA1 and first scan lines G-GLa of the second display area AA2 are connected to each other by first control transistors CTR1, S1 outputs S1O(1) to S1O(n) of an S1 set including a normal S1 unit may be supplied to the first scan lines G-GLa of the first display area AA1 and the first scan lines G-GLa of the second display area AA2 in common.

Referring to FIG. 13, in the repair mode, when all of a first S2 set and a second S2 set are normal, all of S2 outputs S2O(1) to S2O(n) of the first S2 set and the second S2 set may be enabled, and second scan lines G-GLb of the first display area AA1 and second scan lines G-GLb of the second display area AA2 may be separated from each other by second control transistors CTR2.

Moreover, referring to FIG. 13, in the repair mode, when all of a first EM set and a second EM set are normal, all of EM outputs EMO(1) to EMO(n) of the first EM set and the second EM set may be enabled, and emission lines G-GLc of the first display area AA1 and emission lines G-GLc of the second display area AA2 may be separated from each other by third control transistors CTR3.

Referring to FIG. 14, in the repair mode, when at least one of a plurality of first S2 units included in the first S2 set or at least one of a plurality of second S2 units included in the second S2 set is defective, in the first S2 set and the second S2 set, all of S2 outputs S2O(1) to S2O(n) of an S2 set including a defective S2 unit may be disabled, and all of S2 outputs S2O(1) to S2O(n) of an S2 set including no defective S2 unit may be enabled.

In the S2 set including the defective S2 unit, when GCLK(n) of FIG. 6 supplied to the S2 units is blocked, the S2 outputs S2O(1) to S2O(n) may be disabled.

The S2 outputs S2O(1) to S2O(n) of the S2 set including the defective S2 unit may be disabled, and in this case, because second scan lines G-GLb of the first display area AA1 and second scan lines G-GLb of the second display area AA2 are connected to each other by second control transistors CTR2, S2 outputs S2O(1) to S2O(n) of an S2 set including a normal S2 unit may be supplied to the second scan lines G-GLb of the first display area AA1 and the second scan lines G-GLb of the second display area AA2 in common.

Referring to FIG. 14, in the repair mode, when all of the first S1 set and the second S1 set are normal, all of the S1 outputs S1O(1) to S1O(n) of the first S1 set and the second S1 set may be enabled, and the first scan lines G-GLa of the first display area AA1 and the first scan lines G-GLa of the second display area AA2 may be separated from each other by the first control transistors CTR1.

Moreover, referring to FIG. 14, in the repair mode, when all of the first EM set and the second EM set are normal, all of the EM outputs EMO(1) to EMO(n) of the first EM set and the second EM set may be enabled, and the emission lines G-GLc of the first display area AA1 and the emission lines G-GLc of the second display area AA2 may be separated from each other by the third control transistors CTR3.

Referring to FIG. 15, in the repair mode, when at least one of a plurality of first EM units included in the first EM set or at least one of a plurality of second EM units included in the second EM set is defective, in the first EM set and the second EM set, all of EM outputs EMO(1) to EMO(n) of an EM set including a defective EM unit may be disabled, and all of EM outputs EMO(1) to EMO(n) of an EM set including no defective EM unit may be enabled.

In the EM set including the defective EM unit, when ECLK1 and ECLK2 of FIG. 8 supplied to the EM units are blocked, the EM outputs EMO(1) to EMO(n) may be disabled.

The EM outputs EMO(1) to EMO(n) of the EM set including the defective EM unit may be disabled, and in this case, because emission lines G-GLc of the first display area AA1 and emission lines G-GLc of the second display area AA2 are connected to each other by third control transistors CTR2, EM outputs EMO(1) to EMO(n) of an EM set including a normal EM unit may be supplied to the emission lines G-GLc of the first display area AA1 and the emission lines G-GLc of the second display area AA2 in common.

Referring to FIG. 15, in the repair mode, when all of the first S1 set and the second S1 set are normal, all of S1 outputs S1O(1) to S1O(n) of the first S1 set and the second S1 set may be enabled, and the first scan lines G-GLa of the first display area AA1 and the first scan lines G-GLa of the second display area AA2 may be separated from each other by the first control transistors CTR1.

Moreover, referring to FIG. 15, in the repair mode, when all of the first S2 set and the second S2 set are normal, all of the S2 outputs S2O(1) to S2O(n) of the first S2 set and the second S2 set may be enabled, and the second scan lines G-GLb of the first display area AA1 and the second scan lines G-GLb of the second display area AA2 may be separated from each other by the second control transistors CTR2.

In the display apparatus according to one or more embodiments of the present disclosure, a control block may be disposed between a first gate driver set disposed in a first display area and a second gate driver set disposed in a second display area. The control block may turn on or off electrical connections between first scan lines between adjacent S1 sets. The control block may turn on or off electrical connections between second scan lines between adjacent S2 sets. The control block may turn on or off electrical connections between emission lines between adjacent EM sets.

Accordingly, the present disclosure may previously determine whether a gate output is normal or not, based on gate driver sets distributed and disposed in a display area, and may enhance a yield rate of panels through a repair process.

The effects according to the present disclosure are not limited to the above examples, and other various effects may be included in the present disclosure.

While the present disclosure has been particularly shown and described with reference to embodiments thereof, it will be understood by those of ordinary skill in the art that various changes in form and details may be made therein without departing from the spirit and scope of the present disclosure as defined by the following claims.

What is claimed is:

1. A display apparatus, comprising:
a first S1 set disposed in a first display area of a display panel, the first S1 set configured to output an S1 output for pixel driving to first scan lines of the first display area;
a second S1 set disposed in a second display area of the display panel, the second S1 set configured to output the S1 output to first scan lines of the second display area; and
a plurality of first control transistors disposed in a third display area of the display panel disposed between the first display area and the second display area, the plurality of first control transistors configured to turn on or off electrical connections between the first scan lines of the first display area and the first scan lines of the second display area, based on a first control clock signal.

2. The display apparatus of claim 1, wherein the first S1 set comprises a plurality of first S1 units configured to sequentially delay a phase of the S1 output to output a phase-delayed S1 output to the first scan lines of the first display area,
wherein the second S1 set comprises a plurality of second S1 units configured to sequentially delay the phase of the S1 output to output a phase-delayed S1 output to the first scan lines of the second display area, and
wherein each of the plurality of first control transistors comprises a gate electrode receiving the first control clock signal, a first electrode connected to one of the first scan lines of the first display area, and a second electrode connected to one of the first scan lines of the second display area.

3. The display apparatus of claim 2, wherein each of the plurality of first S1 units comprises a plurality of circuit blocks distributed and disposed in the first display area, and
wherein each of the plurality of second S1 units comprises a plurality of circuit blocks distributed and disposed in the second display area.

4. The display apparatus of claim 1, wherein, in a normal display mode and a test mode of the display panel,
a plurality of first S1 units included in the first S1 set sequentially delay a phase of the S1 output to output a phase-delayed S1 output to the first scan lines of the first display area,
a plurality of second S1 units included in the second S1 set sequentially delay the phase of the S1 output to output a phase-delayed S1 output to the first scan lines of the second display area,
the plurality of first control transistors turn off electrical connections between the first scan lines of the first display area and the first scan lines of the second display area, and
in each pixel row, one of the first scan lines of the first display area and one of the first scan lines of the second display area are separated from each other by one of the plurality of first control transistors.

5. The display apparatus of claim 1, wherein, in a repair mode of the display panel,
when at least one of a plurality of first S1 units included in the first S1 set or at least one of a plurality of second S1 units included in the second S1 set is defective,
in the first S1 set and the second S1 set, the S1 output of an S1 set including a defective S1 unit is disabled, and the S1 output of an S1 set including no defective S1 unit is enabled, and
the plurality of first control transistors turn on electrical connections between the first scan lines of the first display area and the first scan lines of the second display area.

6. The display apparatus of claim 1, further comprising:
a first S2 set disposed in the first display area and configured to output an S2 output for pixel driving to second scan lines of the first display area;
a second S2 set disposed in the second display area and configured to output the S2 output to second scan lines of the second display area; and
a plurality of second control transistors disposed in the third display area, the plurality of second control transistors configured to turn on or off electrical connections between the second scan lines of the first display area and the second scan lines of the second display area, based on a second control clock signal.

7. The display apparatus of claim 6, wherein the first S2 set comprises a plurality of first S2 units configured to sequentially delay a phase of the S2 output to output a phase-delayed S2 output to the second scan lines of the first display area,
wherein the second S2 set comprises a plurality of second S2 units configured to sequentially delay the phase of the S2 output to output a phase-delayed S2 output to the second scan lines of the second display area, and
wherein each of the plurality of second control transistors comprises a gate electrode receiving the second control clock signal, a first electrode connected to one of the second scan lines of the first display area, and a second electrode connected to one of the second scan lines of the second display area.

8. The display apparatus of claim 7, wherein each of the plurality of first S2 units comprises a plurality of circuit blocks distributed and disposed in the first display area, and
wherein each of the plurality of second S2 units comprises a plurality of circuit blocks distributed and disposed in the second display area.

9. The display apparatus of claim 6, wherein, in a normal display mode and a test mode of the display panel,
a plurality of first S2 units included in the first S2 set sequentially delay a phase of the S2 output to output a phase-delayed S2 output to the second scan lines of the first display area,
a plurality of second S2 units included in the second S2 set sequentially delay the phase of the S2 output to output a phase-delayed S2 output to the second scan lines of the second display area,
the plurality of second control transistors turn off electrical connections between the second scan lines of the first display area and the second scan lines of the second display area, and
in each pixel row, one of the second scan lines of the first display area and one of the second scan lines of the second display area are separated from each other by one of the plurality of second control transistors.

10. The display apparatus of claim 6, wherein, in a repair mode of the display panel,
when at least one of a plurality of first S2 units included in the first S2 set or at least one of a plurality of second S2 units included in the second S2 set is defective,
in the first S2 set and the second S2 set, the S2 output of an S2 set including a defective S2 unit is disabled, and the S2 output of an S2 set including no defective S2 unit is enabled, and
the plurality of second control transistors turn on an electrical connection between the second scan lines of the first display area and the second scan lines of the second display area.

11. The display apparatus of claim 1, further comprising:
a first EM set disposed in the first display area, the first EM set configured to output an EM output for pixel driving to emission lines of the first display area;
a second EM set disposed in the second display area, the second EM set configured to output the EM output to emission lines of the second display area; and
a plurality of third control transistors disposed in the third display area, the plurality of third control transistors configured to turn on or off electrical connections between the emission lines of the first display area and the emission lines of the second display area, based on a third control clock signal.

12. The display apparatus of claim 11, wherein the first EM set comprises a plurality of first EM units configured to sequentially delay a phase of the EM output to output a phase-delayed EM output to the emission lines of the first display area,
wherein the second EM set comprises a plurality of second EM units configured to sequentially delay the phase of the EM output to output a phase-delayed EM output to the emission lines of the second display area, and
wherein each of the plurality of third control transistors comprises a gate electrode receiving the third control clock signal, a first electrode connected to one of the emission lines of the first display area, and a second electrode connected to one of the emission lines of the second display area.

13. The display apparatus of claim 12, wherein each of the plurality of first EM units comprises a plurality of circuit blocks distributed and disposed in the first display area, and
wherein each of the plurality of second EM units comprises a plurality of circuit blocks distributed and disposed in the second display area.

14. The display apparatus of claim 11, wherein, in a normal display mode and a test mode of the display panel,
a plurality of first EM units included in the first EM set sequentially delay a phase of the EM output to output a phase-delayed EM output to the emission lines of the first display area,
a plurality of second EM units included in the second EM set sequentially delay the phase of the EM output to output a phase-delayed EM output to the emission lines of the second display area,
the plurality of third control transistors turn off electrical connections between the emission lines of the first display area and the emission lines of the second display area, and
in each pixel row, one of the emission lines of the first display area and one of the emission lines of the second display area are separated from each other by one of the plurality of third control transistors.

15. The display apparatus of claim 11, wherein, in a repair mode of the display panel,
when at least one of a plurality of first EM units included in the first EM set or at least one of a plurality of second EM units included in the second EM set is defective,
in the first EM set and the second EM set, the EM output of an EM set including a defective EM unit is disabled, and the EM output of an EM set including no defective EM unit is enabled, and
the plurality of third control transistors turn on electrical connections between the emission lines of the first display area and the emission lines of the second display area.
